(19) United States
(12) Patent Application Publication
(10) Pub. No.: US 2026/0369074 A1
(43) Pub. Date: Nov. 19, 2026

(54) METHOD FOR TRAINING A GRAPH NEURAL NETWORK TO PREDICT A TRAJECTORY OF A VEHICLE

(71) Applicant: Robert Bosch GmbH, Stuttgart (DE)

(72) Inventors: Johannes Goth, Wildberg (DE); Matthias Bitzer, Stuttgart (DE); Maximilian Naumann, Mountain View, CA (US); Reinis Cimurs, Stuttgart (DE); Sebastian Ziesche, Leonberg (DE)

(21) Appl. No.: 19/666,516

(22) Filed: May 4, 2026

(30) Foreign Application Priority Data
May 15, 2025 (DE) 10 2025 118 937.4

(51) Int. Cl. G06V 20/58; G06V 10/82

(52) U.S. Cl. CPC G06V 20/58; G06V 10/82

(57) ABSTRACT

A method including: generating a graph including a respective node nodes for each traffic participant, including a vehicle, in a scene a respective edge between each pair of nodes; inputting the graph into a graph neural network to generate node embeddings and edge embeddings, and to predict the trajectory of the vehicle; determining node losses by determining a node loss for each of one or more nodes employing a large language model (LLM); determining edge losses by determining an edge loss for each of one or more edges employing the LLM; determining a trajectory loss between the predicted trajectory and a ground-truth trajectory; determining a total loss using the node losses, the edge losses, and the trajectory loss; and adapting the graph neural network to reduce the total loss.

### CROSS REFERENCE

The present application claims the benefit under 35 U.S.C. § 119 of Germany Patent Application No. DE 10 2025 118 937.4 filed on May 15, 2025, which is expressly incorporated herein by reference in its entirety.

### BACKGROUND INFORMATION

To control vehicles in the context of at least partially automated (e.g., autonomous) driving, an understanding of the scene the vehicle is in may be required. For this, the vehicle may have sensors to acquire sensor data that represent a surrounding of the vehicle. For example, there are vision-only approaches using images of the surrounding only (and no lidar and/or radar point clouds). C. Pan: “VLP: Vision Language Planning for Autonomous Driving”, arXiv:2401.05577, 2024 (in the following referred to as reference[1]) describes an approach that uses the LLM during training of a vision model to enhance the capabilities of an autonomous driving system.

### SUMMARY

It has been found that the approach of reference [1] is limited regarding generalization, has reduced prediction accuracy when dealing with uncommon situations, and is unable to reason effectively.

The present disclosure relates to a method for training a graph neural network to predict a trajectory of a vehicle. The graph neural network trained according to this method has an increased accuracy (due to an improved reasoning) of the trajectory prediction due to an improved understanding of the scene. This is achieved by, in contrast to the model of reference [1] which is trained on the scene understanding of the ego-vehicle only, training the graph neural network on the scene understanding of (e.g., multiple) traffic participants different from the ego-vehicle (represented by at least one node in the graph) as well as (e.g., multiple) relations (e.g., interactions) between them (represented by the one or more edges in the graph). This includes the scene understanding of other traffic participants that are not on the road, such as bicycles, pedestrians, etc. With this, the graph neural network is trained such that the graph embeddings represent a more generalized scene understanding, viz. a broader context of the scene. This improves the trajectory prediction of the ego-vehicle significantly in scenarios which the ego-vehicle has not been trained on.

Various aspects relate to a computer-implemented method for training a graph neural network to predict a trajectory of a vehicle. According to an example embodiment, the method includes: receiving sensor data representing a plurality of traffic participants in a scene, wherein the plurality of traffic participants includes the vehicle; generating a graph including a plurality of nodes and a plurality of edges, wherein each traffic participant of the plurality of traffic participants is represented by a respective node of the plurality of nodes, and wherein each edge of the plurality of edges is an edge between two nodes and represents a relation (e.g., relative speed, distance, etc.) between the traffic participants represented by the two nodes; inputting the graph into the graph neural network which is configured to, in response to inputting the graph, generate a graph embedding and to predict the trajectory of the vehicle using the graph embedding, wherein the graph embedding includes a respective node embedding for each node of the plurality of nodes and a respective edge embedding for each edge of the plurality of edges; selecting one or more nodes of the plurality of nodes and selecting one or more edges of the plurality of edges, wherein the one or more nodes include at least one node not representing the vehicle; determining node losses by determining a respective node loss for each node of the one or more nodes, wherein the respective node loss of a respective node of the one or more nodes is determined by: generating a node text embedding by inputting a node text description that describes the respective node into a large language model, and determining the respective node loss using a difference between the (generated) node text embedding and the respective node embedding of the respective node (e.g., the difference being represented by a similarity); determining edge losses by determining a respective edge loss for each edge of the one or more edges, wherein the respective edge loss of a respective edge of the one or more edges is determined by: generating an edge text embedding by inputting an edge text description that describes the respective edge into the large language model, and determining the respective edge loss using a difference between the (generated) edge text embedding and the respective edge embedding of the respective edge(e.g., the difference being represented by a similarity); determining a trajectory (e.g., ADE) loss between the predicted trajectory and a ground-truth trajectory; determining a total loss using the node losses, the edge losses, and the trajectory loss; and adapting (e.g., training) the graph neural network to reduce the total loss.

Illustratively, the common knowledge and reasoning capabilities of the large language model (LLM) are transferred to the graph neural network for motion planning. When determining the respective node loss using the difference between the node text embedding and the respective node embedding of the respective node, the node text embedding and the respective node embedding may be mapped to a shared feature space and the loss may then be a difference in this shared feature space. The shared feature space may be one of the feature spaces of the text embeddings or the node or node embeddings or may be a feature space different from the feature spaces of the text embeddings and the node. The same applies to the edge losses such that, when determining the respective edge loss using the difference between the edge text embedding and the respective edge embedding of the respective edge, the edge text embedding and the respective edge embedding may be mapped to a shared feature space and the loss may then be a difference in this shared feature space.

In the following, various examples are described.

Example 1 is the method for training a graph neural network to predict a trajectory of a vehicle as described above.

In Example 2, the subject matter of Example 1 can optionally include that determining the respective node loss using a difference between the node text embedding and the respective node embedding of the respective node includes: generating a negative node text embedding by inputting a negative text description that does not describe the respective node into the large language model; and determining the respective node loss as a contrastive loss to reduce the difference between the node text embedding and the respective node embedding of the respective node (e.g., by increasing their similarity) and to increase a difference between the negative node text embedding and the respective node embedding of the respective node (e.g., by increasing their dissimilarity).

In Example 3, the subject matter of Example 1 or 2 can optionally include that determining the respective edge loss using a difference between the edge text embedding and the respective edge embedding of the respective edge includes: generating a negative edge text embedding by inputting a negative (edge) text description that does not describe the respective edge into the large language model; and determining the respective edge loss as a contrastive loss to reduce the difference between the edge text embedding and the respective edge embedding of the respective edge (e.g., by increasing their similarity) and to increase a difference between the negative edge text embedding and the respective edge embedding of the respective edge (e.g., by increasing their dissimilarity).

Using the contrastive loss according to Examples 2 and 3 allows to significantly increase the accuracy of the trajectory prediction by learning aspects particularly important for driving scenarios. For example, from LLM perspective the words “left” and “right” may be quite similar since both are directions. However, in driving scenarios “left” and “right” shall be very different from one another. Illustratively, the node text embedding and the respective node embedding of the respective node may form a positive pair of the contrastive loss whose similarity is to be increased, whereas the negative node text embedding and the respective node embedding of the respective node form a negative pair of the contrastive loss whose similarity is to be reduce (viz. whose dissimilarity is to be increased). The same applies the edges accordingly.

In Example 4, the subject matter of any one of Examples 1 to 3 can optionally include that a number of nodes of the one or more nodes is less than a number of nodes of the plurality of nodes; and/or wherein a number of edges of the one or more edges is less than a number of edges of the plurality of edges.

This allows to reduce the computational cost during training. For example, due to this the computational cost may be substantially independent of the size of the graph.

In Example 5, the subject matter of any one of Examples 1 to 4 can optionally include that selecting the one or more nodes of the plurality of nodes includes selecting the one or more nodes of the plurality of nodes randomly; and/or wherein selecting the one or more edges of the plurality of edges includes selecting the one or more edges of the plurality of edges randomly.

In Example 6, the subject matter of Example 5 can optionally include that selecting the one or more nodes of the plurality of nodes randomly includes selecting the one or more nodes of the plurality of nodes weighted randomly, wherein a respective weight of a node of the plurality of nodes depends on the respective node embedding of the node and/or the node itself; and/or wherein selecting the one or more edges of the plurality of edges randomly includes selecting the one or more edges of the plurality of edges weighted randomly, wherein a respective weight of an edge of the plurality of edges depends on the respective edge embedding of the edge and/or the edge itself. For example, the nodes may be weighted the higher the greater a difference between their respective node embedding and an average node embedding, wherein the average node embedding is an average over the respective node embeddings of all nodes of the plurality of nodes. Accordingly, edges may be weighted the higher the greater a difference between their respective edge embedding and an average edge embedding, wherein the average edge embedding is an average over the respective edge embeddings of all edges of the plurality of edges.

This weighted random selection allows to train the graph neural network to more diverse features of the traffic participants in the scenario, thereby increasing the accuracy of its trajectory prediction in diverse scenarios. For example, when having two vehicles with one driving at 60 km/h and the other one driving at 100 km/h may be more relevant to the scene understanding than having two vehicle driving at 60 km/h and 65 km/h respectively.

Example 7 is a data processing device configured to carry out the method of any one of Examples 1 to 6.

Example 8 is a vehicle controller configured to control a vehicle using a trajectory predicted by a graph neural network trained according to any one of Examples 1 to 6.

Example 9 is a computer program including instructions which, when executed by a computer, causes the computer to carry out the method according to any one of Examples 1 to 6.

Example 10 is a computer-readable medium including instructions which, when executed by a computer, causes the computer to carry out the method according to any one of Examples 1 to 6.

In the figures, similar reference characters generally refer to the same parts throughout the different views. The figures are not necessarily to scale, emphasis instead generally being placed upon illustrating the principles of the present disclosure. In the following description, various aspects are described with reference to the figures.

### BRIEF DESCRIPTION OF THE DRAWINGS

FIG. 1 shows an at least partially automated vehicle according to various aspects of the present disclosure.

FIG. 2 shows a flow diagram of a computer-implemented method for training a graph neural network to predict a trajectory of a vehicle according to various aspects of the present disclosure.

FIG. 3 shows a flow diagram illustrating various aspects of the method of the present disclosure.

### DETAILED DESCRIPTION OF EXAMPLE EMBODIMENTS

The following detailed description refers to the figures that show, by way of illustration, specific details and aspects of this disclosure in which subject matter of the present disclosure may be practiced. Other aspects may be utilized and structural, logical, and electrical changes may be made without departing from the scope of the present disclosure. The various aspects of this disclosure are not necessarily mutually exclusive, as some aspects of this disclosure can be combined with one or more other aspects of this disclosure to form new aspects.

In the following, various examples will be described in more detail.

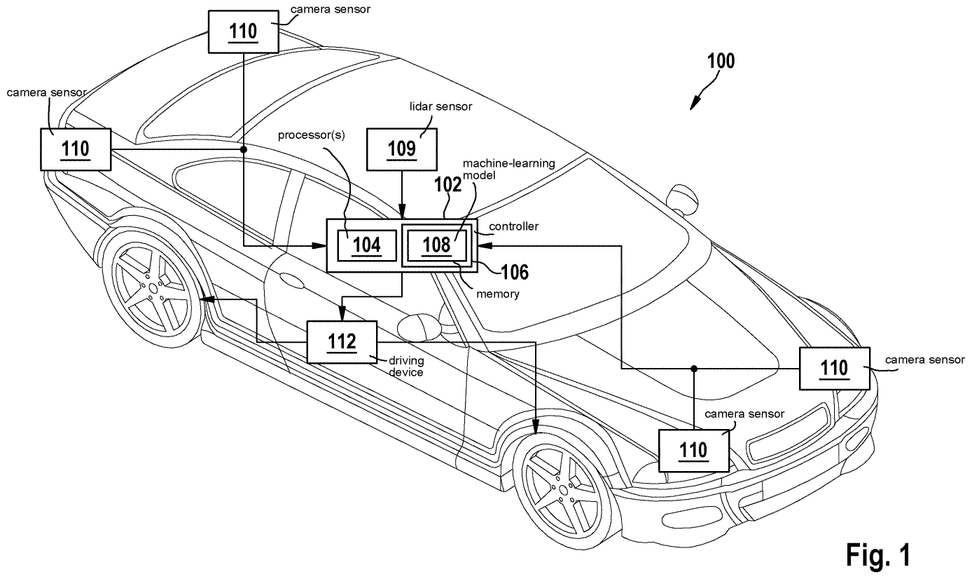

FIG. 1 shows an at least partially automated vehicle 100 according to various aspects. The at least partially automated vehicle 100 shown in FIG. 1 and described below by way of example is an exemplary computer-controlled device serving for illustration. Thus, although various aspects of the computer-implemented method are detailed with reference to the vehicle 100, it is understood that this serves for illustration and that any other computer-controlled device that uses trajectory prediction may employ the computer-implemented method detailed herein. Another computer-controlled device that uses trajectory prediction may be, for example, a robot device (short: robot), such as an industrial robot (e.g., in the form of a robot arm for moving, assembling or machining a workpiece, for bin-picking, etc.), a manufacturing robot, a maintenance robot, a domestic robot, a medical robot, a production machine, etc., as well as any other type of trajectory predicting based computer-controlled device.

For control of the vehicle 100, the vehicle 100 may include a (vehicle) controller 102 configured to implement an interaction with an environment of the vehicle 100 according to a control program. The term “controller” may be understood as any type of logic implementing entity, which may include, for example, a circuit and/or a processor capable of executing software stored in a storage medium, firmware, or a combination thereof, and which can issue instructions, e.g. to an actuator in the present example. The controller may be configured, for example, by program code (e.g., software) to control the operation of a system, a vehicle in the present example.

In the present example, the controller 102 may include one or more processors 104 and a memory 106 storing code and data based on which the processor 104 controls the vehicle 100. According to various embodiments, the controller 102 controls the vehicle 100 on the basis of a machine-learning model 108 stored in the memory 106.

To be able to control a driving task of the vehicle 100, the controller 102 may use sensor data which represent a surrounding (e.g., an environment) of the vehicle 100. For this, the vehicle 100 may include one or more sensors 109, 110 each providing respective sensor data that represent at least part of the surrounding of the vehicle 100. A sensor of the one or more sensors 109, 110 may be, for example, an imaging sensor and/or proximity sensor, such as a camera (e.g., a standard camera, a digital camera, an infrared camera, a stereo camera, etc.), a radar sensor, a LIDAR sensor, an ultrasound sensor, etc. A sensor of the one or more sensors 109, 110 may be configured to acquire an image showing at least part of the surrounding of the vehicle 100. An image may be an RGB image, an RGB-D image, or a depth image (also referred to as a D image). A depth image described herein may be any type of image that includes (3-dimensional) depth information. Illustratively, a depth image may have information about one or more objects in the surrounding of the vehicle 100. For example, a depth image described herein may include a point cloud provided by a LIDAR sensor and/or a radar sensor. For example, a depth image may be an image with depth information provided by a LIDAR sensor. According to various aspects, the vehicle 100 may include one or more lidar sensors 109 and/or one or more camera sensors 110. It is understood that the vehicle 100 may further include other sensors, such as a Global Navigation Satellite System (GNSS, e.g., a Global Positioning System, GPS), a speedometer, an altimeter, a gyroscope, a velocity sensor, etc., and the controller 102 may also employ sensor data provided by these other sensors for control of the vehicle 100. The controller 102 may be configured to control the vehicle 100 based on an output of the machine-learning model 108 responsive to inputting the sensor data into the machine-learning model 108.

The vehicle 100 may include a driving device 112 for driving the vehicle 100. The controller 102 may be configured to determine, using an output of the machine-learning model 108, a control parameters for controlling the vehicle 100. The controller 102 may be configured to control an operation of the vehicle 100 (e.g., by controlling the driving device 112 via a control signal) in accordance with the control parameters.

The at least partially automated vehicle 100 may be an automated vehicle or an autonomous vehicle. A level of autonomy of a vehicle may be described or determined by the Society of Automotive Engineers (SAE) level of the vehicle (e.g., as defined in SAE J3016). For example, the at least partially automated vehicle 100 may be a partially automated vehicle (according to SAE level 2), a highly automated vehicle (according to SAE level 3), a fully automated vehicle (according to SAE level 4) or an autonomous vehicle (according to SAE level 5).

An at least partially automated vehicles can, in general, take over driving tasks autonomously. For this, a machine-learning model 108 may predict a trajectory of the vehicle 100 and this trajectory is then employed for motion planning of the vehicle 100. To ensure the safety of occupants and other road users (e.g., cyclists, pedestrians, etc.), it is necessary for systems that perform driving tasks autonomously to be highly safety-critical. Hence, the predicted trajectory should be as accurate as possible.

According to various aspects, the machine-learning model 108 may include a graph neural network that is trained to predict the trajectory with improved accuracy. This is achieved by improving the scene understanding of the graph neural network, namely by having graph embeddings that represent a more generalized scene understanding.

The graph neural network may be generated (e.g., learned or trained) while the vehicle 100 is inoperative. The generated graph neural network may be used during operation of the vehicle 100 to predict trajectories that are then used to plan driving tasks to be performed by the vehicle 100. Optionally, the generated graph neural network may be additionally trained during operation of the vehicle 100.

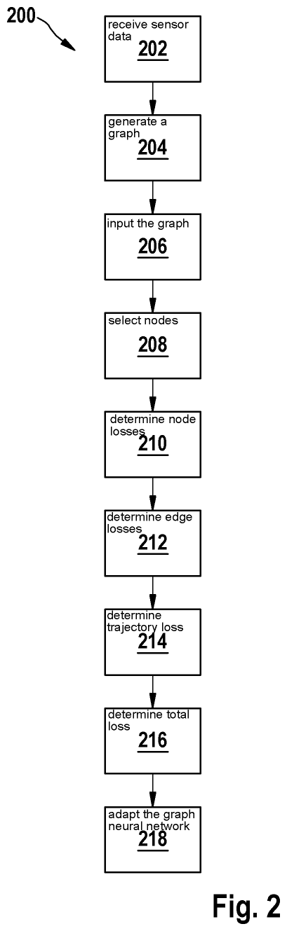

FIG. 2 shows a flow diagram of a (computer-implemented) method 200 for training the training a graph neural network to predict a trajectory of a vehicle according to various aspects.

The method 200 may include (in 202) receiving sensor data representing a plurality of traffic participants in a scene. The plurality of traffic participants may include the vehicle.

The method 200 may include (in 204) generating a graph including a plurality of nodes and a plurality of edges. Each traffic participant of the plurality of traffic participants may be represented by a respective node of the plurality of nodes. Each edge of the plurality of edges may be an edge between two nodes and may represent a relation between the traffic participants represented by the two nodes.

The method 200 may include (in 206) inputting the graph into the graph neural network which is configured to, in response to inputting the graph, generate a graph embedding and to predict the trajectory of the vehicle using the graph embedding. The graph embedding may include a respective node embedding for each node of the plurality of nodes and a respective edge embedding for each edge of the plurality of edges.

The method 200 may include (in 208) selecting one or more nodes of the plurality of nodes and selecting one or more edges of the plurality of edges. The one or more nodes may include at least one node not representing the vehicle. Hence, the at least one node may be different from a node representing the vehicle. According to various aspects, two or more nodes may be selected. In some aspects, the one or more edges may include at least one edge not representing a relation to the vehicle. Hence the at least one edge may be an edge between two nodes with none of them representing the vehicle.

The method 200 may include (in 210) determining node losses by determining a respective node loss for each node of the one or more nodes. The respective node loss of a respective node of the one or more nodes is determined by: generating a node text embedding by inputting a node text description that describes the respective node into a large language model, and determining the respective node loss using a difference between the (generated) node text embedding and the respective node embedding of the respective node.

The method 200 may include (in 212) determining edge losses by determining a respective edge loss for each edge of the one or more edges. The respective edge loss of a respective edge of the one or more edges is determined by: generating an edge text embedding by inputting an edge text description that describes the respective edge into the large language model, and determining the respective edge loss using a difference between the (generated) edge text embedding and the respective edge embedding of the respective edge.

The method 200 may include (in 214) determining a trajectory (e.g., ADE) loss between the predicted trajectory and a ground-truth trajectory.

The method 200 may include (in 216) determining a total loss using the node losses, the edge losses, and the trajectory loss.

The method 200 may include (in 218) adapting (e.g., training) the graph neural network to reduce the total loss (e.g., using backpropagation).

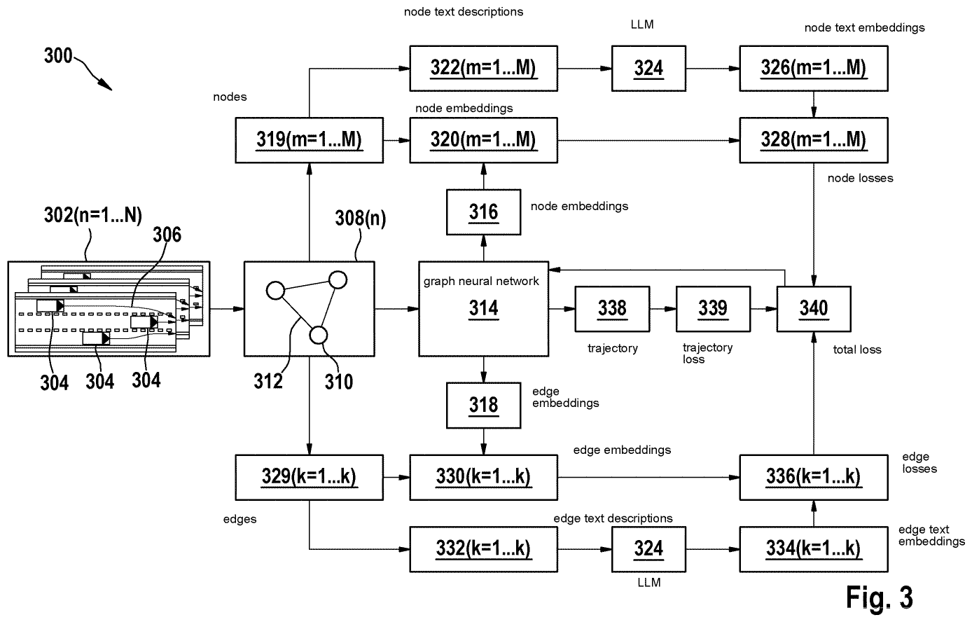

In the following, various aspects of the method 200 are described in further detail with reference to FIG. 3.

The training may be carried out iteratively for a dataset 302(n=1 to N) that includes respective sensor data 302(n) for a corresponding scene. N may be any integer number equal to or greater than one. The sensor data may include any kind of raw sensor data or preprocessed sensor data that represent the corresponding scene. In an example, the sensor data may include a bird-eye view image as exemplarily illustrated in FIG. 3. In some aspects, multi-view images of the scene may be received and the bird-eye view image may be generated therefrom. In another example, the sensor data may include (e.g., numerical) datasets representing the scene. Hence, the sensor data 302(n) may be any kind of data representing the plurality of traffic participants and their interactions in a scene. In general, the sensor data 302(n) may be any kind of data that allow to generate a graph 308(n) therefrom with the graph 308(n) including the plurality of nodes 310 (with a respective node for each traffic participant) and the plurality of edges 312 (with a respective edge between each pair of nodes).

Then, in 206, the graph 308(n) may be input into the graph neural network 314 to generate the graph embedding and to predict the trajectory 338 of the vehicle using the graph embedding. The graph embedding may include a plurality of node embeddings 316 with a respective node embedding for each node of the plurality of nodes 310 and may include a plurality of edge embeddings 318 with a respective edge embedding for each edge of the plurality of edge 312. The plurality of node embeddings 316 are generated by the convolution layers of the graph neural network.

According to various aspects, one or more nodes 319(m=1 to M) of the plurality of nodes 310, and hence one or more node embeddings 320(m=1 to M) of the plurality of node embeddings 316, may be selected (in 208). M may be any integer number equal to or greater than one. According to various aspects, M may be less than a total number of nodes of the plurality of nodes 310 (thereby reducing the computational cost during training). The one or more nodes 319(m=1 to M) may include at least one node 319(m*) different from the node that represents the vehicle. Hence, the at least one node 319(m*) may represent a traffic participant different from the vehicle. The one or more nodes 319(m=1 to M) of the plurality of nodes 310 may be selected randomly. A respective weight of a node of the plurality of nodes 310 may depend on the respective node embedding of the node and/or the node itself. According to various aspects, the one or more nodes 319(m=1 to M) of the plurality of nodes 310 may be selected weighted randomly with nodes 319(m) being weighted the higher the greater a difference between their respective node embedding 320(m) and an average node embedding over the plurality of node embeddings 316. With this, nodes with more diverse features are more likely included in the training process, thereby increasing the accuracy of the trajectory prediction in diverse scenarios.

For each node 319(m) of the one or more nodes 319(m=1 to M), a respective node text description 322(m) may be provided or generated. The respective node text description 322(m) may describe the corresponding node 319(m). Optionally, for generating the respective node text description 322(m) a text template may be used that may then be filled using the information about the corresponding node 319(m). An example of the respective node text description 322(m) may be: “This car drives with 100 km/h on the left lane of a three lane highway and has an acceleration of 2 m/s²”.

Each respective node text description 322(m) may then input into the LLM 324 to generate a respective node text embedding 326(m). Then, a respective node loss 328(m) may be determined using a difference between the respective node text embedding 326(m) and the respective node embedding 320(m) of the respective node 319(m). As detailed herein, the respective node text embedding 326(m) and the respective node embedding 320(m) may be mapped to a shared feature space first and the difference between the respective node text embedding 326(m) and the respective node embedding 320(m) of the respective node 319(m) may then be a difference in this shared feature space. Regarding this determination of the difference in the shared feature space it is referred to reference [1].

According to various aspects, the respective node loss 328(m) may be determined using a contrastive loss. In this case, the respective node text description 322(m) may include the above-described text description that describes the corresponding node 319(m) as a positive node text description and may further include a negative node text description that does not describe the corresponding node 319(m) (e.g., that contradicts the corresponding node 319(m)). An example of the negative node text description associated with the above-descripted example of the positive text description may be: “This car drives with 10 km/h on the right lane of a three lane highway and has an acceleration of 5 m/s²”. The positive node text description may result in the (positive) node text embedding and the negative node text description may also be input into the LLM 324 to generate a negative node text embedding. Hence, the respective node text embedding 326(m) may include the positive node text embedding and the negative node text embedding. The contrastive loss may then be determined using a similarity between the positive node text embedding and the respective node embedding 320(m) of the respective node 319(m) and a dissimilarity between the negative node text embedding and the respective node embedding 320(m) of the respective node 319(m). Using the contrastive loss further increases the accuracy of the trajectory prediction since driving scenario related feature differences can be learned. For example, from LLM perspective the words “left” and “right” may be quite similar since both are directions, but in driving scenarios “left” and “right” are opposite to one another and shall be clearly differentiated.

With this, one or more node losses 328(m=1 to M) are determined. Accordingly, one or more edge losses 336(k=1 to K) may be determined.

For this, one or more edges 329(k=1 to K) of the plurality of edges 312, and hence one or more edge embeddings 330(k=1 to K) of the plurality of edge embeddings 318, may be selected (in 208). K may be any integer number equal to or greater than one. In some aspects, K may correspond to M (viz. K=M), and in other aspects K may be different from M (viz. K≠M). According to various aspects, K may be less than a total number of edges of the plurality of edges 312 (thereby reducing the computational cost during training). The one or more edges 329(k=1 to K) of the plurality of edges 312 may be selected randomly. A respective weight of an edge of the plurality of edges 312 may depend on the respective edge embedding of the edge and/or the edge itself. According to various aspects, the one or more edges 329(k=1 to K) of the plurality of edges 312 may be selected weighted randomly with edges 329(k) being weighted the higher the greater a difference between their respective edge embedding 330(k) and an average edge embedding over the plurality of edge embeddings 318. With this, edges with more diverse features are more likely included in the training process, thereby increasing the accuracy of the trajectory prediction in diverse scenarios.

For each edge 329(k) of the one or more edges 329(k=1 to K), a respective edge text description 332(k) may be provided or generated. The respective edge text description 332(k) may describe the corresponding edge 329(k). Optionally, for generating the respective edge text description 332(k) a text template may be used that may then be filled using the information about the corresponding edge 329(k). An example of the respective edge text description 332(k) may be: “Other vehicle is a truck. It is driving 20 km/h faster. It is driving behind the vehicle.”.

Each respective edge text description 332(k) may then input into the LLM 324 to generate a respective edge text embedding 334(k). Then, a respective edge loss 336(k) may be determined using a difference between the respective edge text embedding 334(k) and the respective edge embedding 330(k) of the respective edge 329(k). As detailed herein, the respective edge text embedding 334(k) and the respective edge embedding 332(k) may be mapped to a shared feature space first and the difference between the respective edge text embedding 334(k) and the respective edge embedding 330(k) of the respective edge 329(k) may then be a difference in this shared feature space. Regarding this determination of the difference in the shared feature space it is referred to reference [1].

According to various aspects, the respective edge loss 336(k) of the one or more edge losses 336(k=1 to K) may be determined using a contrastive loss. In this case, the respective edge text description 332(k) may include the above-described text description that describes the corresponding edge 329(k) as a positive edge text description and may further include a negative edge text description that does not describe the corresponding edge 329(k) (e.g., that contradicts the corresponding edge 329(k)). An example of the negative edge text description associated with the above-descripted example of the positive edge text description may be: “Other vehicle is a bike. It is driving 60 km/h faster. It is driving on the left of the vehicle.”. The positive edge text description may result in the (positive) edge text embedding and the negative edge text description may also be input into the LLM 324 to generate a negative edge text embedding. Hence, the respective edge text embedding 334(k) may include the positive edge text embedding and the negative edge text embedding. The contrastive loss may then be determined using the similarity between the positive edge text embedding and the respective edge embedding 330(k) of the respective edge 329(k) and a dissimilarity between the negative edge text embedding and the respective edge embedding 330(k) of the respective edge 329(k).

The respective sensor data 302(n) in the dataset 302(n=1 to N) may be associated with a corresponding ground-truth trajectory 306 (indicated by the arrows in the bird-eye view images in FIG. 3). According to various aspects, a trajectory loss 339 may be determined (in 214) between the predicted trajectory 338 and the corresponding ground-truth trajectory 306. As an example, the trajectory loss 339 may be an advection-dispersion equation (ADE) loss. However, it is understood that this serves as an example and that the trajectory loss 339 may be any kind of loss between two trajectories.

In 214, the total loss 340 may be determined using the one or more node losses 328(m=1 to M), the one or more edge losses 336(k=1 to K), and the trajectory loss 339. The total loss 340 may be a (e.g., weighted) sum of the one or more node losses 328(m=1 to M), the one or more edge losses 336(k=1 to K), and the trajectory loss 339. For example, an average (e.g., mean) node loss of the one or more node losses 328(m=1 to M) and an average (e.g., mean) edge loss of the one or more edge losses 336(k=1 to K) may be determined. The total loss 340 may be a (e.g., weighted) sum of the average node loss, the average edge loss, and the trajectory loss 339.

Then, in 216 the graph neural network 314 may be adapted to reduce the total loss 340. Using the losses resulting from the text embeddings described herein results in a transfer of the reasoning capabilities of the LLM 324 to the graph neural network 314 and using multiple node embeddings 320(m=1 to M) and multiple edge embeddings 330(k=1 to K) in each iteration allows to train the graph neural network 314 to learn a more general scene understanding, thereby improving the accuracy of the trajectory prediction in diverse scenarios (e.g., scenarios not observed during training).

Illustratively, according to various aspects, a language-conditioned Graph neural network 314 with a more generalized scene understanding is provided.

A method for controlling a robot (e.g., the vehicle 100 or another robot device) may include acquiring sensor data which represent a surrounding of the robot (e.g., an image (e.g., acquired using one or more sensors as described herein) which shows one or more other traffic participants in the vicinity of the robot). The method for controlling the robot may include generating a graph from the sensor data and feeding the graph into the graph neural network 314 trained according to method 200 to predict a trajectory 338, and controlling the robot (e.g., the vehicle 100) based on the predicted trajectory 338.

While in the above embodiments, the approach of FIG. 2 is applied to control the vehicle 100, it may be applied for computing a control signal for controlling any technical system in a scenario where trajectory prediction plays a role.

What is claimed is:

1. A computer-implemented method for training a graph neural network to predict a trajectory of a vehicle, the method comprising the following steps:
receiving sensor data representing a plurality of traffic participants in a scene, wherein the plurality of traffic participants includes the vehicle;
generating a graph including a plurality of nodes and a plurality of edges, wherein each traffic participant of the plurality of traffic participants is represented by a respective node of the plurality of nodes, and wherein each edge of the plurality of edges is an edge between two nodes and represents a relation between the traffic participants represented by the two nodes;
inputting the graph into the graph neural network which is configured to, in response to inputting the graph, generate a graph embedding, and predict the trajectory of the vehicle using the graph embedding, wherein the graph embedding includes a respective node embedding for each node of the plurality of nodes and a respective edge embedding for each edge of the plurality of edges;
selecting one or more nodes of the plurality of nodes, and selecting one or more edges of the plurality of edges, wherein the one or more nodes include at least one node not representing the vehicle;
determining node losses by determining a respective node loss for each node of the one or more nodes, wherein the respective node loss of a respective node of the one or more nodes is determined by:
generating a node text embedding by inputting a node text description that describes the respective node into a large language model, and
determining the respective node loss using a difference between the node text embedding and the respective node embedding of the respective node;
determining edge losses by determining a respective edge loss for each edge of the one or more edges, wherein the respective edge loss of a respective edge of the one or more edges is determined by:
generating an edge text embedding by inputting an edge text description that describes the respective edge into the large language model, and
determining the respective edge loss using a difference between the edge text embedding and the respective edge embedding of the respective edge;
determining a trajectory loss between the predicted trajectory and a ground-truth trajectory;
determining a total loss using the node losses, the edge losses, and the trajectory loss; and
training the graph neural network to reduce the total loss.

2. The method according to claim 1, wherein the determining of the respective node loss using the difference between the node text embedding and the respective node embedding of the respective node includes:
generating a negative node text embedding by inputting a negative node text description that does not describe the respective node into the large language model; and
determining the respective node loss as a contrastive loss to reduce the difference between the node text embedding and the respective node embedding of the respective node and to increase a difference between the negative node text embedding and the respective node embedding of the respective node.

3. The method according to claim 1, wherein the determining of the respective edge loss using the difference between the edge text embedding and the respective edge embedding of the respective edge includes:
generating a negative edge text embedding by inputting a negative edge text description that does not describe the respective edge into the large language model; and
determining the respective edge loss as a contrastive loss to reduce the difference between the edge text embedding and the respective edge embedding of the respective edge and to increase a difference between the negative edge text embedding and the respective edge embedding of the respective edge.

4. The method according to claim 1, wherein at least one of:
a number of nodes of the one or more nodes is less than a number of nodes of the plurality of nodes, or
a number of edges of the one or more edges is less than a number of edges of the plurality of edges.

5. The method according to claim 1, wherein at least one of:
the selecting of the one or more nodes of the plurality of nodes includes selecting the one or more nodes of the plurality of nodes randomly, or
the selecting of the one or more edges of the plurality of edges includes selecting the one or more edges of the plurality of edges randomly.

6. The method according to claim 5, wherein:
the selecting of the one or more nodes of the plurality of nodes randomly includes selecting the one or more nodes of the plurality of nodes weighted randomly, wherein a respective weight of a node of the plurality of nodes depends on the respective node embedding of the node and/or the node itself; and/or
the selecting of the one or more edges of the plurality of edges randomly includes selecting the one or more edges of the plurality of edges weighted randomly, wherein a respective weight of an edge of the plurality of edges depends on the respective edge embedding of the edge and/or the edge itself.

7. A data processing device configured to carry out a method for training a graph neural network to predict a trajectory of a vehicle, the method comprising the following steps:
receiving sensor data representing a plurality of traffic participants in a scene, wherein the plurality of traffic participants includes the vehicle;
generating a graph including a plurality of nodes and a plurality of edges, wherein each traffic participant of the plurality of traffic participants is represented by a respective node of the plurality of nodes, and wherein each edge of the plurality of edges is an edge between two nodes and represents a relation between the traffic participants represented by the two nodes;
inputting the graph into the graph neural network which is configured to, in response to inputting the graph, generate a graph embedding, and predict the trajectory of the vehicle using the graph embedding, wherein the graph embedding includes a respective node embedding for each node of the plurality of nodes and a respective edge embedding for each edge of the plurality of edges;
selecting one or more nodes of the plurality of nodes, and selecting one or more edges of the plurality of edges, wherein the one or more nodes include at least one node not representing the vehicle;
determining node losses by determining a respective node loss for each node of the one or more nodes, wherein the respective node loss of a respective node of the one or more nodes is determined by:
generating a node text embedding by inputting a node text description that describes the respective node into a large language model, and
determining the respective node loss using a difference between the node text embedding and the respective node embedding of the respective node;
determining edge losses by determining a respective edge loss for each edge of the one or more edges, wherein the respective edge loss of a respective edge of the one or more edges is determined by:
generating an edge text embedding by inputting an edge text description that describes the respective edge into the large language model, and
determining the respective edge loss using a difference between the edge text embedding and the respective edge embedding of the respective edge;
determining a trajectory loss between the predicted trajectory and a ground-truth trajectory;
determining a total loss using the node losses, the edge losses, and the trajectory loss; and
training the graph neural network to reduce the total loss.

8. A vehicle controller configured to control a vehicle using a trajectory predicted by a graph neural network, the graph neural network being trained by performing the following steps comprising:
receiving sensor data representing a plurality of traffic participants in a scene, wherein the plurality of traffic participants includes the vehicle;
generating a graph including a plurality of nodes and a plurality of edges, wherein each traffic participant of the plurality of traffic participants is represented by a respective node of the plurality of nodes, and wherein each edge of the plurality of edges is an edge between two nodes and represents a relation between the traffic participants represented by the two nodes;
inputting the graph into the graph neural network which is configured to, in response to inputting the graph, generate a graph embedding, and predict the trajectory of the vehicle using the graph embedding, wherein the graph embedding includes a respective node embedding for each node of the plurality of nodes and a respective edge embedding for each edge of the plurality of edges;
selecting one or more nodes of the plurality of nodes, and selecting one or more edges of the plurality of edges, wherein the one or more nodes include at least one node not representing the vehicle;
determining node losses by determining a respective node loss for each node of the one or more nodes, wherein the respective node loss of a respective node of the one or more nodes is determined by:
generating a node text embedding by inputting a node text description that describes the respective node into a large language model, and
determining the respective node loss using a difference between the node text embedding and the respective node embedding of the respective node;
determining edge losses by determining a respective edge loss for each edge of the one or more edges, wherein the respective edge loss of a respective edge of the one or more edges is determined by:
generating an edge text embedding by inputting an edge text description that describes the respective edge into the large language model, and
determining the respective edge loss using a difference between the edge text embedding and the respective edge embedding of the respective edge;
determining a trajectory loss between the predicted trajectory and a ground-truth trajectory;
determining a total loss using the node losses, the edge losses, and the trajectory loss; and
training the graph neural network to reduce the total loss.

9. A non-transitory computer-readable medium on which are stored instructions for training a graph neural network to predict a trajectory of a vehicle, the instructions, when executed by a computer, causing the computer to perform the following steps:
receiving sensor data representing a plurality of traffic participants in a scene, wherein the plurality of traffic participants including the vehicle;
generating a graph including a plurality of nodes and a plurality of edges, wherein each traffic participant of the plurality of traffic participants is represented by a respective node of the plurality of nodes, and wherein each edge of the plurality of edges is an edge between two nodes and represents a relation between the traffic participants represented by the two nodes;
inputting the graph into the graph neural network which is configured to, in response to inputting the graph, generate a graph embedding, and predict the trajectory of the vehicle using the graph embedding, wherein the graph embedding includes a respective node embedding for each node of the plurality of nodes and a respective edge embedding for each edge of the plurality of edges;
selecting one or more nodes of the plurality of nodes, and selecting one or more edges of the plurality of edges, wherein the one or more nodes include at least one node not representing the vehicle;
determining node losses by determining a respective node loss for each node of the one or more nodes, wherein the respective node loss of a respective node of the one or more nodes is determined by:
generating a node text embedding by inputting a node text description that describes the respective node into a large language model, and
determining the respective node loss using a difference between the node text embedding and the respective node embedding of the respective node;
determining edge losses by determining a respective edge loss for each edge of the one or more edges, wherein the respective edge loss of a respective edge of the one or more edges is determined by:
generating an edge text embedding by inputting an edge text description that describes the respective edge into the large language model, and
determining the respective edge loss using a difference between the edge text embedding and the respective edge embedding of the respective edge;
determining a trajectory loss between the predicted trajectory and a ground-truth trajectory;
determining a total loss using the node losses, the edge losses, and the trajectory loss; and
training the graph neural network to reduce the total loss.
